(19) United States
(12) Patent Application Publication
(10) Pub. No.: US 2026/0268350 A1
(43) Pub. Date: Sep. 10, 2026

(54) SYSTEM FOR ONLINE LEAD ACQUISITION & DISTRIBUTION, INCORPORATING LEAD QUALITY GRADING, AGENT MATCHING AND APPOINTMENT SETTING

(71) Applicant: Leadscorz Inc., Seattle, WA (US)

(72) Inventors: Santiago Díez Pérez, León (ES); Bernard Patrick Murphy, Seattle, WA (US)

(21) Appl. No.: 19/557,008

(22) Filed: Mar. 4, 2026

Related U.S. Application Data
(60) Provisional application No. 63/766,588, filed on Mar. 4, 2025.

(51) Int. Cl. G06Q 30/0201; G06Q 10/1093; G06Q 40/08

(52) U.S. Cl. CPC G06Q 30/020121; G06Q 10/1093; G06Q 40/082

(57) ABSTRACT

A system and method for lead matching and appointment setting in the private consumer insurance space includes modules for lead intake, lead grading, provider/agent database management, lead-provider matching, appointment scheduling, and data analytics. The method involves receiving and grading leads, matching them with appropriate providers/agents, facilitating appointment scheduling, enabling enrollment in chosen Medicare plans, and continuously analyzing data to improve system performance. This integrated approach streamlines the process from initial lead acquisition to facilitating final plan enrollment, improving efficiency and accuracy for insurance providers, and enhancing the experience for Medicare-eligible individuals seeking coverage.

### CROSS REFERENCE

This application claims priority to U.S. Provisional Application No. 63/766,588, filed Mar. 4, 2025, “SYSTEM FOR ONLINE LEAD ACQUISITION & DISTRIBUTION, INCORPORATING LEAD QUALITY GRADING, AGENT MATCHING AND APPOINTMENT SETTING,” the content of which is hereby incorporated by reference.

### TECHNICAL FIELD

The present application relates to systems and methods for processing consumer-initiated sales leads, illustrated herein for its use case involving “insurance” leads, wherein the acquired leads have identified specific insurance products or carriers of interest to the consumer, AI-based algorithms are utilized for assessing the relative quality of the lead with respect to the Consumer's propensity to engage with an Agent and/or enroll in an insurance plan, matching those consumers with a pool of appropriately licensed Agents, and enabling consumers to self-schedule a selected type of appointment with a specific licensed agent or an agency representative. The illustrative embodiments described below include middleware platform innovations for assessing lead quality and optimizing lead distribution through AI/ML (Artificial Intelligence/Machine Learning)-driven algorithms designed to achieve optimized agent matching and consumer-preferred appointment coordination. The disclosed embodiments are especially useful in, but not limited to, the context of facilitating Private Medicare insurance sales. Moreover, a key innovation is the integration of dynamic lead quality grading reflecting engagement propensity, which informs both initial lead purchasing decisions and subsequent agent matching for optimized lead distribution efficiency.

### BACKGROUND

The Private Medicare market within the United States highlights several challenges and opportunities faced by the broader Insurance Provider sector (aka; Carriers) and their licensed Sales Agents, as well as Independent Insurance Brokers and Agencies (also known as Field Marketing Organizations (“FMO's”) or Managing General Agents (“MGA's”). As is the case with the marketing of many Consumer financial products, traditional marketing methods are often unable to effectively connect qualified, high-intent Medicare-eligible individuals with licensed agents who can assist such consumers with understanding the complexities of plan options, selection of an optimal plan, and facilitating the sales process and subsequent enrollment into a selected plan. Applicant has developed an innovative system designed to address these challenges by streamlining this entire process and empowering consumers by enabling them to engage with an appropriate Agent on their own terms, only after they have self-selected a plan, or plans, of interest. The system also benefits the insurance marketers and their agents by facilitating the acquisition and intelligent distribution of consumer-generated leads in an automated and quality-optimized manner that matches the Consumer to the Agent/lead purchaser based on mutual availability and desired method of engagement. Since the problems addressed are especially acute in the Private Medicare market, this section examines the current state of Medicare marketing, explores the problems inherent in traditional approaches, and analyzes the potential benefits and drawbacks of Applicant's inventive system.

### Current Private Medicare Marketing Landscape

Private Medicare marketing (primarily involving “Medicare Part C” or “Medicare Advantage” insurance products, and “Medicare Supplemental” insurance products—aka, “Medi-Gap Insurance”) is a dynamic and competitive landscape. Insurance Providers rely heavily on various direct and third-party marketing channels to reach potential Consumer enrollees. These channels can be summarized as follows:

| Channel | Description | Benefits | Challenges |
|---|---|---|---|
| Direct Mail | Targeted mailers | Allows for | Can be expensive |
| | sent to individuals | personalized | and may be |
| | | messaging and | perceived as |
| | | broad reach | intrusive |
| Telemarketing | Phone calls to | Enables direct | Requires careful |
| | potential enrollees | interaction and | adherence to |
| | | personalized | regulations and |
| | | communication | can be perceived |
| | | | negatively if |
| | | | overly aggressive |
| Television and | Broadcast media | Reaches a large | Can be costly and |
| Radio Advertising | campaigns | audience and can | may not |
| | | build brand | effectively target |
| | | awareness | specific |
| | | | demographics |
| Digital Marketing | Online channels, | Allows for | Requires ongoing |
| | including websites, | targeted | adaptation to |
| | social media, and | advertising, | evolving digital |
| | search engine | interactive content, | trends and may not |
| | advertising | and data-driven | reach all segments |
| | | optimization | of the Medicare |
| | | | population |
| Educational Events | In-person or online | Provides | Can be resource- |
| and Seminars | events to provide | opportunities for | intensive and may |
| | information and | direct interaction, | not reach a large |
| | engage with | relationship | audience |
| | potential enrollees | building, and | |
| | | detailed plan | |
| | | explanations | |

In addition to these marketing channels, the Centers for Medicare and Medicaid Services (CMS), a governmental oversight agency, provides detailed information on both traditional (government-provided) Medicare and Private Medicare Advantage plans in a 100-page booklet mailed annually to every beneficiary¹. The federal government also funds State Health Insurance Assistance Programs (SHIPs) in each state to provide consumers with unbiased information about Medicare benefits, and offer personalized help with understanding and selection of coverage options¹. However, despite these resources and the efforts of CMS to regulate Medicare marketing and ensure ethical practices, challenges persist.

Problems with Traditional Medicare Marketing

Several key issues plague the current Medicare marketing process. One of the most significant concerns is the prevalence of misleading and/or biased information. Advertisements and marketing materials can be confusing or even purposely misleading, and because much of the information provided is generated by marketers representing specific or a limited number of plans, consumers are often not provided with the complete set of Medicare Plan options available in their market. The inherent bias in such marketing makes it difficult for consumers to be in control of their product education process and to make more fully informed decisions². For example, a study by the Kaiser Family Foundation found that many Medicare beneficiaries distrust television advertisements for Medicare Advantage plans, particularly those featuring celebrity endorsements and claims of “free” benefits⁴. This distrust stems from a perception that these advertisements often prioritize sales of a particular brand or brands—over identifying the best available plan for serving the consumer's unique lifestyle and healthcare needs. Most consumers need or want personalized guidance from an experienced and trustworthy agent to help them choose the best plan for their needs.

Unfortunately, aggressive sales tactics remain a problem. Some agents and brokers employ high-pressure sales techniques, potentially leading consumers to enroll in plans that are not suitable for their needs². This issue is compounded by the frequent use of unsolicited contact—Consumers often receive unwanted phone calls, text messages, emails, and mailers, leading to frustration and distrust². While CMS and other governmental regulations generally prohibit unsolicited contact from plan marketers or by third-party marketing organizations (aka; “TPMO's”) promoting private Medicare plans and/or generating sales leads which are sold to plan marketers, consumers often receive calls or texts from agents or brokers selling various products who have obtained the consumer's information through illegitimate lead generation or re-selling activities⁵.

Adding to these challenges is the concern that some marketing practices specifically target vulnerable populations, such as those with cognitive impairments or low health literacy³. These individuals may be more susceptible to misleading information or aggressive sales tactics, making them particularly vulnerable to enrolling in inappropriate plans. A Senate Finance Committee report highlights that unscrupulous actors often target individuals who are “dually-eligible” for Medicare and Medicaid, as well as those with cognitive impairments³. This has fueled recent increases in “Rapid Dis-enrollments,” a perennial problem faced by Carriers and Broker/Agents wherein Beneficiaries having buyer's remorse, or who find that the plan in which they enrolled did not meet their needs, quickly dis-enroll. Rapid Dis-enrollments reduce the Life-time Value (“LTV”) of enrollments, adversely impact the efficiency and reliability of the whole lead generation, lead processing and enrollment system, and impose a direct financial burden on all parties in the supply-chain (the consumer, the agent, and carrier).

To help consumers navigate these challenges, it is important that they be aware of potential red flags when interacting with agents or brokers. These red flags include:
Unsolicited contact: Be wary of phone calls, emails, texts, or visits from agents you have not given permission to contact you⁵.
Pressure tactics: Agents should not pressure you to enroll in a plan or make you feel like you could lose your benefits if you don't⁵.
Requests for personal information: Be cautious about sharing your Medicare or Social Security numbers with agents, especially if you have not initiated the contact⁵.
Misleading information: Verify any claims made by agents about plan coverage and benefits with official sources like Medicare.gov or your SHIP⁵.

Current systems lack intelligent middleware to preserve consumers' intent by capturing data from their plan selection session through agent matching and lead delivery, and to maintain the digital association of a lead with meta data from the consumer session that is required to document compliance with CMS, FCC, TCPA and other government-mandated rules that are designed to protect consumers. Existing solutions also fail to dynamically match consumer-identified plan preferences with applicable agent expertise, as required, across multiple electronic platforms and scheduling modalities.

These problems with traditional Private Medicare marketing, particularly involving third-party Lead Sellers, Sales Agents and Brokers, contribute to undermine consumer trust and create barriers to effective enrollment and ensuring Consumer satisfaction with insurance products.

### Regulatory Considerations

A system operating in the Medicare insurance space must comply with the regulatory framework currently governing Medicare marketing, and with proposed extension of similar regulations into the broader consumer marketing sector. Key regulations include the CMS Marketing Guidelines, which provide detailed rules for plan advertising, agent conduct, agent compensation, and consumer interactions⁶. These guidelines address various aspects of marketing, including requirements for obtaining consumer consent to be contacted, the topical content of marketing materials, the use of the “Medicare” name and logo, and permissible communication practices.

A crucial regulation is the prohibition of unsolicited contact. Plan marketers generally cannot contact consumers via phone calls or text messages and market to them without their “explicit prior consent”⁵. This means that tele-marketing and other forms of electronic outreach are permissible only when consumers have explicitly agreed to be contacted or are already enrolled in a plan offered by the marketer being represented.

A further regulation in the Medicare space concerns the allowable timeline of Agents' providing “marketing or sales information” in communication with a consumer contacted via outbound solicitations by the agent or their associates. In such circumstances, agents are prohibited from engaging in a “sales” presentation or enrolling a consumer in a plan, prior to 48-hours after initial contact and completion of a “Scope of Appointment” (SOA) agreement. An SOA documents the Consumer's eligibility and consent to receive information on specific Medicare insurance product(s) only if in the form of a signed and dated document, or a recorded and time-stamped audio file.

In addition to these existing regulations, CMS has recently implemented new one-to-one consent and topical content rules for Third Party Marketing Organizations (TPMOs) that engage in Medicare-related advertising⁷. These rules require TPMOs to obtain express written consent from individuals before sharing their personal data with other TPMOs for marketing purposes. The new rules also prohibit TPMO's from sharing Consumers' information (i.e., re-selling leads to other marketers) without having obtained explicit prior consent to do so. This measure aims to protect consumer privacy and prevent the unauthorized sharing of sensitive consumer information.

There is a strong need in the market for a technology-based solution to the problems described above. Accordingly, an over-arching goal of the present invention is to automate, integrate and generally improve the digital acquisition and processing of sales leads, and to improve the efficiency in which Private Medicare and other insurance and financial services are marketed and sold to consumers. Inclusive to these objectives is incorporating processes for ensuring compliance with all applicable regulations, including the new CMS and FCC consent and topical content rules. Additional goals of the present invention are to provide a technological system to help maintain ethical sales, marketing and consumer data management practices that protect consumer privacy rights. Moreover, the primary objectives are maximizing agent efficiency and return on marketing investment through optimizing the lead purchasing process and facilitating intelligent lead distribution, rather than impacting initial consumer plan selection.

### SUMMARY

The present disclosure describes a system and method for streamlining the sales process for certain consumer financial products and services by lead capture and matching with a pool of appropriate sales agents or customer service representatives, providing for appointment type selection and scheduling with a specific agent, facilitating required consent confirmation, and delivering related consumer-to-agent communications to initiate direct engagement and support the sales process. Specific to this use-case, we address the application of systems and processes within the Private Medicare Insurance space. This invention builds upon Applicant's existing technologies to create a seamless, end-to-end solution for connecting eligible individuals who have expressed interest in a particular insurance plan or provider, with an appropriate agent, broker or carrier to facilitate their evaluation and subsequent enrollment in such plans, or supporting the marketing and purchase of other consumer products or services. Underlying these novel methods, Applicant's system provides for the electronic data collection, data processing automation, real-time agent calendar reading, sales process activity reporting, and connecting of all involved parties via electronic communications, adding commercial value to the core supported services.

The system employs AI/ML algorithms to match consumers who have identified specific insurance products or carriers with agents possessing corresponding expertise, licensure, and availability. This matching process enables consumers to select from multiple appointment types and time slots, while ensuring the marketers' agents receive leads which are aligned with their licensure and are distributed to them based on their fit with the Consumer's needs, their availability, and their historical sales performance metrics.

The disclosed embodiment of the inventive system offers several advantages for both consumers and marketers. By leveraging advanced algorithms, an AI-based rules engine, and incorporated data analysis, the system efficiently matches consumers with an Agent that meets their specific needs and preferences, as well as incorporating the utilization of a preferential profile of Agents' past performance in the successful enrollment of candidate consumers. This improved matching and the subsequent communications that it facilitates, can lead to greater consumer and agent satisfaction, resulting in higher lead conversions and a reduction in the rates of rapid dis-enrollment.

The system's automated lead processing and appointment scheduling capabilities can enhance efficiency for both the marketers' agents and consumers. This increased efficiency can save time and resources, allowing agents to more effectively schedule their workdays and focus on providing personalized support to consumers who need it. Moreover, the inventive system promotes increased efficiency and transparency within the consumer financial services sector by empowering consumers to pre-select an Agent based on their specific plan or carrier(s) of interest, by incorporating clear and concise information about Agent licensing, availability, and professional credentials. This transparency empowers consumers to initiate the contact with an aligned agent on their own terms after researching specific plans. This process enables consumers to make informed decisions and reduces the likelihood of confusion or misunderstanding. By capturing only leads initiated by a consumer after they have been self-matched to an appropriate plan, or plans, and self-selection from among multiple options for engaging the assistance of a corresponding licensed agent, the system can also help reduce aggressive sales tactics.

Consumer-initiated lead submission inherently shifts away from exposure to high-pressure sales techniques and can foster greater trust between consumers and insurance providers due to the apparent level of intent to purchase by the Consumer. Finally, facilitating a self-scheduling option via the system's front-end interface further indicates intent, adds greater control by the consumer over the engagement event, and allows for more self-direction of the entire purchasing process. The flexibility enabled by Applicant's system caters to diverse consumer preferences and promotes a more consumer-centric approach to shopping and purchase of a broad range of insurance products and other financial services offerings.

For insurance providers, the system's data-driven approach can lead to a more efficient and cost-effective marketing process. By facilitating more informative and helpful plan research by consumers, the leads qualified and processed by this method generally result in higher-intent Consumer prospects being delivered to agents, which are inherently more likely to enroll. Providers can therefor better optimize their marketing spend and improve their return on investment in third-party generated sales leads, including the anticipated resulting reduction of “Rapid Dis-enrollments,” due to the invention's accommodation of “high intent, consumer-initiated” calls, appointments and/or submitted form requests to be contacted. This process supports more self-directed consumer research of insurance product options, arming consumers with more personalized comparisons of coverages and costs, thereby resulting in inherently higher “consumer intent to purchase.” This combination results in higher consumer confidence and reduces the key metric impacting providers' top-line marketing performance metric—their “Lead Cost Per Enrollment.”

This integrated approach streamlines the entire process from initial lead acquisition to a final plan sale, improving efficiency for insurance marketers and enhancing the experience for individual Consumers seeking appropriate coverages.

### BRIEF DESCRIPTION OF THE DRAWINGS

FIG. 1 is a block diagram illustrating the system architecture of the lead capture, agent matching and appointment setting system, according to an embodiment of the present disclosure.

FIG. 2 is a flow diagram illustrating the operation of the lead matching and appointment setting, according to an embodiment of the present disclosure.

### DETAILED DESCRIPTION OF ILLUSTRATIVE EMBODIMENTS

### Overview

Applicant has devised a new system designed to improve the Medicare (and other private insurance and Consumer financial products) marketing process by integrating several key functions. The system includes a Matching Algorithm, which uses AI and machine learning to analyze consumer data and match individuals with suitable insurance providers and plans. In addition, a Grading Engine is used to grade the “propensity of a lead to convert”. This facilitates real-time sales lead processing of consumer-initiated leads that may already include selection of a specific insurance plan(s) or identification of an insurance marketer of interest, enabling a subsequent matching of consumer's insurance needs and selected plan from available offerings to available and appropriately-licensed Insurance Agents. The Grading Engine output directly informs real-time agent matching by weighting agent performance metrics according to imbedded lead attributes and lead quality tiers. Higher-grade leads can be preferentially routed to higher-performing agents, and lower-grade leads routed to less costly staff or automated and customized response tactics such as email or SMS text.

Once the consumer identifies a product of interest and elects to connect with an Agent, they then select an engagement method, and if selecting to schedule an appointment, designates the type of appointment, the system may also facilitate either an inbound phone call by the Consumer, or the submission of a “Form Request” for a future call-back by an Agent or other Representative of the marketer. By facilitating ‘Consumer choice”, the system ensures that consumers connect on their terms with appropriate representatives who can provide personalized guidance and answer their questions if needed.

To further enhance its effectiveness, the system continuously collects data on lead dispositioning as feedback to refine its Matching Algorithm, optimize its lead grading algorithm, and improve efficiency of lead distribution and overall performance. For example, there may be feedback data regarding the Agents' performance in engaging with consumers, making sales presentations/completing applications, and closing sales. This feedback can be used to set prioritization and rank Agents for dialing sequences by the system for the purpose of rewarding higher producing agents and optimizing sales. This commitment to continuous improvement ensures that the system adapts to evolving consumer needs, changes in Agent performance, and to market dynamics affecting both consumer and agent behavior.

Importantly, Applicant is committed to ethical lead generation practices and is a member of the Lead Quality Alliance, a Not-For-Profit trade association dedicated to promoting fully compliant lead generation and marketing integrity standards. This commitment to ethical practices aligns with the company's mission to improve the insurance marketing process by shifting the focus from aggressive sales to consumer empowerment, providing unbiased product information, and facilitating more informed decision-making.

Applicant is the owner of a granted patent and pending applications related to lead scoring (also referred to as grading), management and distribution. The granted patent is U.S. Pat. No. 11,775,912 B2, Oct. 3, 2023, titled “SYSTEMS AND METHODS FOR REAL-TIME LEAD GRADING”. This patent discloses a system for real-time lead grading using machine learning techniques. Key features include:
Converting leads to benchmark values based on conversion event records
Encoding leads as vectors and clustering them
Assigning grades to clusters based on conversion rates
Using a trained neural network to map new leads to cluster labels/grades assigned by modeling based on a marketer's historical lead outcomes

The pending application is U.S. Provisional Application No. 63/551,669, titled “GRADE-BASED REAL-TIME BIDDING FOR SALES LEADS”, filed on Feb. 9, 2024. This application builds on the lead grading technology to create a real-time bidding system for leads. Key features include:
Grading incoming leads using a predictive model
Calculating bid prices by applying grade-based boost factors to a baseline cost per lead
Submitting bids in real-time exchanges
Adjusting the baseline cost per lead over time based on winning bid prices

Another pending application owned by Applicant is U.S. Provisional Application No. 63/650,043, titled “REAL-TIME DYNAMIC MODEL CALIBRATION FOR LEAD SCORING SYSTEMS,” filed on May 21, 2024. This application describes a system for real-time dynamic predictive model calibration system for lead scoring (aka; grading). The invention addresses the challenge of maintaining accurate lead scoring models as lead purchasing practices, market trends and consumer behaviors evolve over the period in which a predictive model is in use. The system combines a binary classifier for predicting lead conversion probabilities with a clustering module that groups leads into performance-based segments.

The lead matching to insurance plan(s), subsequent appointment setting, lead distribution system described in the present application provides a comprehensive solution for the Medicare insurance market. It leverages advanced algorithms and data analysis techniques to efficiently connect Medicare-eligible individuals with suitable insurance providers and plans. The system builds upon Applicant's existing lead grading and distribution technologies, extending their capabilities to create a seamless, end-to-end process that benefits both insurance providers and consumers.

The system begins by receiving and evaluating leads, utilizing Applicant's established grading methodologies to assess lead quality. It then matches these leads with appropriate Medicare insurance providers and their agents based on factors such as lead grade, agent expertise, agent licensure, plan offerings, and geographical considerations. Once a match is made, the system facilitates appointment setting, considering the availability and preferences of both the lead and the agent.

Throughout the entire process, the system collects data and feedback, continuously refining its matching algorithms and improving the overall efficiency of the lead distribution and conversion process in the Medicare insurance space. The system's agent matching prioritizes not only licensure and availability but also agent-specific historical conversion data to maximize enrollment rates.

### System Architecture

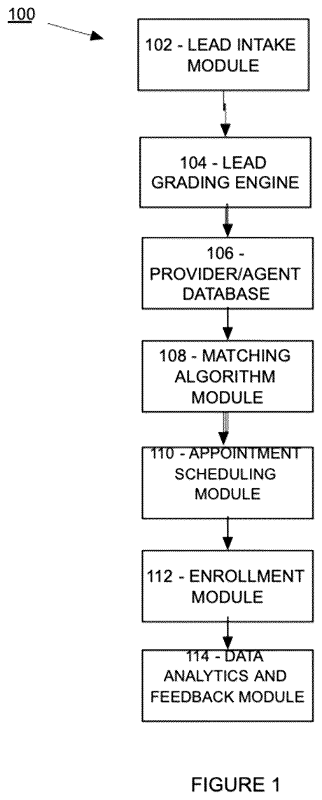

FIG. 1 illustrates the system architecture of the lead matching, appointment setting, and lead distribution system 100 according to an embodiment of the present disclosure. The system 100 includes a Lead Intake Module 102, a Lead Grading Engine 104, a Provider/Agent Database 106, a Matching Algorithm Module 108, an Appointment Scheduling Module 110, Lead Distribution function, and a Data Analytics and Feedback Module 114. The platform preferably operates agnostic to upstream plan selection tools, processing any lead containing consumer-identified plan/carrier preferences and appointment type requirements. (FIG. 1 also shows an Enrollment Module 112. It should be noted that, although a preferred embodiment of the system prepares the lead for, and to some extent can facilitate the enrollment process by providing the relevant lead data to populate the enrollment forms and helps to ensure accuracy, the act of enrolling is typically performed on a third-party platform or Provider websites.)

The Lead Intake Module 102 receives incoming leads from various sources, including online forms, referrals, and third-party lead generators. This module captures essential information about potential Medicare insurance customers, such as age, location, current coverage status, and specific insurance coverage needs or preferences. It can be implemented as a multi-channel data collection system. Structurally, it may consist of a web server hosting online forms, an API endpoint for receiving data from third-party lead generators, and a database for storing incoming lead information.

Programmatically, the module can be implemented using a RESTful API built with Node.js and Express.js for handling incoming data, form validation and sanitization using available libraries, and database integration for efficient data storage and retrieval. The module would implement data encryption for sensitive information and include rate limiting to prevent abuse.

The Lead Grading Engine 104 evaluates the quality of incoming leads using Applicant's established grading methodologies. This engine assigns a grade to each lead based on factors such as demographic information, engagement level, and likelihood of engagement and/or sales conversion. The Lead Grading Engine 104 can be implemented as a machine learning-based system. Structurally, it may include a feature extraction pipeline, a trained machine learning model, and a model serving infrastructure. Programmatically, this could involve using Python with libraries like scikit-learn or TensorFlow for model development, implementing a gradient boosting algorithm (e.g., XGBoost) for lead scoring, deploying the model using tools like Flask or FastAPI for real-time predictions, and implementing A/B testing capabilities to continuously improve the model's performance. The engine would also include a feedback loop mechanism to update the model based on actual conversion data.

The Provider/Agent Database 106 stores comprehensive information about insurance providers and their agents. This includes details about available plans, agent expertise and specializations, geographical coverage areas, and performance metrics. The Provider/Agent Database 106 can be implemented as a distributed, scalable database system. Structurally, it may consist of a primary relational database for structured data, a document store for unstructured data (e.g., agent bios), and a caching layer for frequently accessed data. Programmatically, this could involve using PostgreSQL for the relational database, with proper indexing and partitioning, implementing MongoDB for storing unstructured data, utilizing Redis for caching and improving read performance, and developing a data access layer for efficient querying. The database would implement robust backup and recovery mechanisms, as well as data replication for high availability.

The Matching Algorithm Module 108 is the core component of the system, responsible for pairing graded leads with appropriate providers and agents. This module utilizes advanced algorithms that consider lead grades, provider/agent characteristics, plan suitability, and other relevant factors to identify the most promising matches. The module can be implemented as a multi-factor optimization system. Structurally, it may include a rules engine for applying business logic, a machine learning model for predictive matching, and a scoring and ranking system. Programmatically, this could involve implementing a rules engine using a library like easy-rules in Java, developing a collaborative filtering algorithm using Python and surprise library, utilizing Apache Spark for large-scale data processing and matching, and implementing a custom scoring algorithm that weighs multiple factors (e.g., lead grade, agent performance, geographical proximity). The module would include monitoring and logging capabilities to track matching performance and identify areas for improvement.

The Appointment Scheduling Module 110 facilitates the process of setting up meetings between matched leads and agents. This module manages availability calendars, sends notifications and reminders, and allows for easy rescheduling if needed. The module can be implemented as a distributed scheduling system. Structurally, it may include a calendar management system, a notification service, and a conflict resolution engine. Programmatically, this could involve using the iCal standard for calendar data representation, implementing a scheduling algorithm that considers time zones and availability windows, developing a notification system using a message queue like RabbitMQ, and creating a RESTful API for integration with external calendar systems (e.g., Google Calendar, Outlook). The module would implement retry mechanisms for failed notifications and include analytics to optimize scheduling efficiency.

The Data Analytics and Feedback Module 114 continuously collects and analyzes data from all stages of the lead matching, appointment setting, and selling process. This module generates insights that are used to refine the matching algorithms, optimizing the grading algorithms, to improve overall system performance, and provide valuable feedback to both providers and agents. This module can be implemented as a real-time analytics and reporting system. Structurally, it may include a data warehouse for storing historical data, a stream processing engine for real-time analytics, and a visualization and reporting platform. Programmatically, this could involve using Apache Kafka for data ingestion and stream processing, implementing a data warehouse, developing real-time dashboards, and creating scheduled jobs for generating periodic reports. The module would implement data anonymization techniques to ensure privacy compliance and include anomaly detection algorithms to identify unusual patterns or potential issues in the system.

### Operation

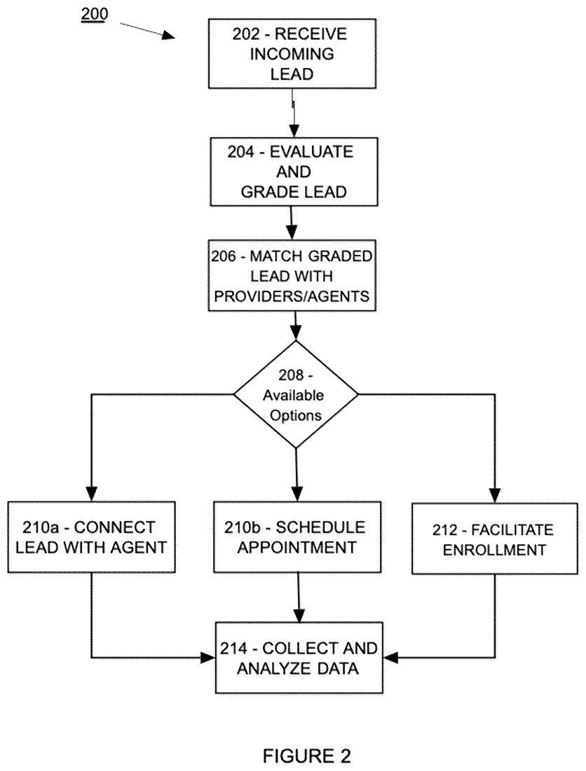

FIG. 2 illustrates the operation of the lead matching, appointment setting, and lead distribution system according to an embodiment of the present disclosure. The process 200 begins with the receipt of a new lead through the Lead Intake Module 102 (step 202). The system captures relevant information about the potential insurance customer, including demographic data, current coverage status, and specific needs or preferences.

Next, the Lead Grading Engine 104 evaluates the lead and assigns a grade based on various quality factors (step 204). This grade helps prioritize leads and informs the matching process.

The Matching Algorithm Module 108 then analyzes the graded lead along with data from the Provider/Agent Database 106 to identify suitable matches (step 206). The algorithm considers factors such as lead grade, agent expertise, plan offerings, geographical location, and historical performance data to determine the most promising provider-agent combinations for the lead. See below for further details of this process.

At step 208, agent options qualified for the consumer-identified plans/carriers, including licensure verification and historical performance metrics, are presented to the consumer. This step can be customized based on provider preferences, with some opting for direct assignment rather than lead choice.

After a match is confirmed, the Appointment Scheduling Module 110 facilitates the process of setting up a meeting between the lead and the selected agent (step 210). The module manages availability, sends notifications, and handles any necessary rescheduling. This scheduling process coordinates multiple constraint optimization including agent expertise tiers, geographic licensure boundaries, and consumer-preferred communication channels.

Following the appointment, the system assesses whether the lead is ready to enroll in an insurance plan (step 212). If the lead is prepared to move forward, they may be directed to the Enrollment Module 112, if provided. The Enrollment Module may be configured to guide them through the enrollment process for their chosen plan (step 214). If the lead is not yet ready to enroll, the system can schedule follow-up actions or provide additional information as needed.

Throughout this process, the Data Analytics and Feedback Module 114 collects data and generates insights (step 216). This information is used to continuously refine the matching algorithms, improve system performance, and provide valuable feedback to providers and agents.

### Implementation of Matching Algorithm

The matching process between leads and agents can be implemented using a multi-faceted approach. The Matching Algorithm Module can employ a combination of rule-based filtering and machine learning techniques to identify the most suitable agents for each lead. Initially, the system can apply a set of predefined rules to filter out agents who do not meet basic criteria, such as geographical proximity or specialization in the required type of insurance plan. Following this initial filtering, a machine learning model, such as a collaborative filtering algorithm or a neural network, can be used to predict the likelihood of a successful match based on historical data of similar leads and agents.

The system can also incorporate a dynamic scoring mechanism that considers various factors such as the lead's preferences, the agent's performance metrics, and the complexity of the lead's needs. This scoring can be continuously updated based on feedback from previous interactions and outcomes. To further refine the matching process, the system can implement A/B testing by occasionally presenting alternative matches and analyzing the results to improve the algorithm's performance over time.

In a preferred implementation, the matching subsystem has two main components:
Constraints solver,
Recommendation engine.

The Constraint Solver is used to find the subset of agents that meet all the requirements of the request. We define two sets of constraints:
1. Hard constraints: These are the constraints that represent a requirement. In this case these are things like geographical constraints (the agent must be licensed in a particular state), product types, availability, or appointment types.
2. Soft constraints: These are constraints that are not required, but “nice to have”. This is used to model things like the number of appointments that have been assigned to an agent, since is preferable to spread the appointments over a larger set of agents, if the agent has an appointment right before or after the selected slots, etc., since the soft constraints will vary depending on context.

Considering all the constraints (hard and soft) we use a technique called “Constraint based search” to find the optimal subset of agents that:
Meet all the hard constraints
Are optimal based on the evaluation of the soft constraints

To do this, a solver algorithm may be used or a tool like MiniZinc (open-source constraint modeling languages) or Z3 may be employed. The current solver algorithm first filters the agents based on the hard constraints, then uses Linear Programming to find the (sub)optimal list of agents.

The Recommendation engine is used after the list of optimal agents is calculated. The lead is scored for each agent, picking the agent that has the higher score. This is like the process described in Applicant's above-cited patent (U.S. Pat. No. 11,775,912 B2), agent and appointments data are provided to the model as input variables along with the rest of the variables considered for the lead.

### Compliance and Agentic Systems

As noted above in the Background section, the Private Medicare industry is required to meet certain legal compliance requirements. The SOA (Scope of Appointment) is a key component of gaining consent and keeping the transaction compliant. It can only be documented with either a recording of the call with a Customer Service Agent (CSR) or a licensed Agent, which includes responses to the required questions, or the Beneficiary needs to sign a document of the same. One of these documentations needs to be “in the possession” of the licensed Agent when they connect with the Beneficiary. This can be accomplished by storing and providing a link to the audio file of the CSR/Beneficiary conversation.

The other components for documenting “consent/permission to contact” specifically in this example use case for Medicare insurance are evidence of “Prior explicit One-to-One” consent being provided, and that the proper notifications mandated by the Telephone Consumer Protection Act of 1991 (TCPA) have been presented. For appointments, it is also necessary that the 48-hour rule has been adhered to by affixing the timestamp when the SOA is acquired, and when the appointment is scheduled.

Since the inventive system provides an end-to-end solution, it can gather evidence along the way, making sure the transaction is the product of the legitimate interest of the beneficiary. This evidence is in many different formats. AI agents may be used to summarize this evidence and generate the paper trail needed (SOA and other documents) from the calls captured during the process described above. Initial tests suggest that it is possible for an AI agent to listen to the recording of a CSR call, generate a transcription that then is used to fill in a SOA form. The same process can be used to generate data leads from calls, something that is useful for normalizing the information and sending it to other systems.

### Implementation of Appointment Setting Process

For appointment setting, the system can utilize a sophisticated scheduling algorithm that considers multiple constraints simultaneously. This algorithm can consider the availability of both the lead and the agent, preferred communication channels, time zone differences, and even predicted duration of the appointment based on the complexity of the lead's needs. To optimize the scheduling process, the system can employ a constraint satisfaction problem (CSP) solver, which can efficiently manage multiple variables and constraints to find optimal time slots.

The appointment scheduling module can also incorporate smart features such as automatic reminders sent through multiple channels (e.g., email, SMS, push notifications) and the ability to easily reschedule or cancel appointments. To enhance user experience, the system can offer a visual calendar interface that allows leads to see available time slots and select their preferred options. Additionally, the module can implement a queueing system for high-demand agents, allowing leads to join a waitlist for cancelled appointments.

### Implementation of Self-Enrollment Process

A self-enrollment process, if provided via third party systems, can be optimized through a user-friendly, step-by-step interface that guides leads through the enrollment process. This interface can be designed as a responsive web application or a native mobile app, ensuring accessibility across various devices. The system can implement smart form filling, which pre-populates fields required by the self-enrollment system, based on information already collected in Applicant system about the lead, reducing the time and effort required to complete the enrollment.

To ensure compliance and security, a connected self-enrollment system can integrate with Applicant system to identity verification services and implement secure document upload functionality for any required supporting documentation.

By implementing these optimized approaches for matching, appointment setting, lead distribution, disposition tracking and sales performance analytics, the system can significantly enhance the efficiency and effectiveness of Medicare and other insurance sales processes, while providing a seamless and user-friendly experience for leads.

Compliance with One-to-One Consent and Topical Content Rules

As discussed above, the inventive system uniquely enables adherence to the consent rules for Private Medicare, and it enables the capture and subsequent delivery of the SOA to the Agent in near real-time, and thereby providing them, and the ultimate Plan Provider (the Carrier) with required access to that documentation. More specifically, the system employs prescriptive rules for the data field requirements that each publishing source generating a lead must present to the system for the lead to be processed. This includes fields containing all required information for documenting proper “One-to-One” consent, the presentation of TCPA notification language, and information describing the session content (i.e.; Plan Descriptors or ID #) to document the alignment of the Consumer's identified plan preferences with an appropriately licensed Agent to whom they are subsequently connected with. Furthermore, the system employs mechanisms for capturing a subsequently recorded Scope-of-Appointment audio file between Consumer and Agent or an intermediary scheduler, and the electronic storage of such files for future retrieval by authorized parties seeking to confirm compliance with regulatory requirements.

### Example User Experience

To illustrate the improved experience provided by this invention, let us consider the journey of Sarah, a 64-year-old woman approaching Medicare eligibility and seeking out information regarding Medicare Insurance options:

In the traditional system, Sarah might have been overwhelmed by the complexity of Medicare insurance options and by (often unsolicited) calls from various insurance agents, many offering plans that do not suit her specific needs. She would have had to navigate multiple websites, compare plans on her own, and then independently engage a Sales Agent, potentially agreeing to purchase a plan without fully researching available options.

With Applicant's new plan comparison tool, lead generation & agent matching, appointment setting and lead distribution system, Sarah's experience can be significantly enhanced. After locating a connected Online Plan Comparison shopping site (one owned & operated either by Applicant, or an integrated Third Party Marketing Partner), and entering only her basic demographic information (i.e.; age, gender, location), and optionally any chronic health conditions, drug prescriptions, and preferred Healthcare Provider information, the sites' algorithm evaluates her needs based on her eligibility, provided health information, and coverage preferences. The plan comparison algorithm utilizes AI-modeling and access to various databases to return a curated set of plan options that best match Sarah's input profile data and coverage preferences, acceptance by her preferred healthcare Providers, and include the projected annual healthcare costs of each plan.

Sarah is then prompted to select a plan(s) of interest and presented with options for arranging contact with a Sales Agent (scheduling an appointment, calling a direct number to immediately speak with an Agent, or completing an online form to request a call-back from an appropriately qualified and licensed Agent, or by a Customer Service Representative). Completing any of these options will result in generation of a “Sales Lead” within the Applicant system, which then applies the methods and processes described herein to process the lead and distribute it to an appropriate Agent. Or if an Agent is not available, her lead is routed to a Help Center Representative for further qualification and assistance with ultimately connecting Sarah with a Licensed Agent.

In the former scenario, the matching algorithm identifies one or more agents licensed to offer Sarah's preferred plan types, able to connect via her chosen method, and available to connect on her timing. Sarah reviews the agent profiles and selects Jane, an appropriately licensed agent with excellent reviews and expertise in the type of coverage Sarah is considering.

The appointment scheduling module allows Sarah to book a virtual meeting with Jane at a convenient time. Before the appointment, Sarah receives helpful information from Jane about her Agency credentials, Medicare basics, and the type of plans they will be discussing.

During their video call, Jane verifies Sarah's eligibility and consent, explains Sarah's options clearly, answering all her questions. Sarah feels confident in her understanding of the plans and decides she is ready to enroll. Jane walks Sarah through the application questions and completes the application on behalf of Sarah, ensuring all information is accurate.

Throughout the process, the system collects data on Sarah's interactions, preferences, and decision-making process, as well as Jane's documentation of their encounters via Jane's updating of her Agency Management CRM system. This information is fed back to Applicant's systems to refine the matching algorithm for future leads and provides valuable insights to both lead generators and insurance providers about consumer preferences and behavior.

This streamlined, personalized experience represents a significant improvement over the traditional Medicare marketing and sales management processes, reducing stress and confusion for consumers while improving efficiency for insurance providers and agents.

### CONCLUSION

The lead generation, lead-agent matching, appointment setting, and lead distribution and tracking system described in this disclosure represents a significant advancement in the field of lead management and distribution, particularly within the Medicare insurance space. By integrating lead grading, intelligent matching, appointment facilitation, and performance tracking capabilities, the system provides a comprehensive solution that benefits both insurance providers and consumers.

The system's ability to accurately match leads with appropriate providers and agents, facilitates efficient appointment setting, and offers a streamlined lead distribution and tracking process that addresses many of the challenges traditionally associated with many types of insurance sales. It has the potential to significantly improve conversion rates for insurance providers while simultaneously enhancing the experience of eligible individuals seeking appropriate coverage.

Moreover, the continuous data collection and analysis performed by the system enable ongoing refinement and improvement of the matching algorithms and overall process efficiency. This adaptive capability ensures that the system remains effective and relevant in the face of changing market conditions and consumer preferences.

While the embodiments described herein focus on the Medicare insurance market, the principles and technologies underlying this system could be adapted and applied to other insurance markets or industries where lead matching and customer acquisition play a crucial role. The modular nature of the system architecture allows for flexibility and customization to meet the specific needs of different markets or use cases.

In summary, this invention represents a novel and non-obvious advancement in lead management technology, building upon and extending Applicant's existing innovations to create a more comprehensive and effective solution with novel and positive improvements in marketing practices and lead management processes within the broad Consumer Insurance and Financial Services industries.

### CITATIONS

1. Role of Marketing in Medicare Beneficiaries' Coverage Choices|Commonwealth Fund, accessed Jan. 25, 2025, https://www.commonwealthfund.org/publications/explainer/2023/jan/role-marketing-medicare-beneficiaries-coverage-choices
2. Misleading Medicare Marketing: What to Look Out For, accessed Jan. 25, 2025, https://www.ncoa.org/article/misleading-medicare-marketing-dont-be-fooled-during-medicare-open-enrollment/
3. www.finance.senate.gov, accessed Jan. 25, 2025, https://www.finance.senate.gov/imo/media/doc/Deceptive%20Marketing%20Practices%20Flourish%20in%20Medicare%20Advantage.pdf
4. What Do People with Medicare Think About the Role of Marketing . . . , accessed Jan. 25, 2025, https://www.kff.org/medicare/report/what-do-people-with-medicare-think-about-the-role-of-marketing-shopping-for-medicare-options-and-their-coverage/
5. Protecting Yourself from Marketing Violations::State Health . . . , accessed Jan. 25, 2025, https://www.shiphelp.org/about-medicare/blog/protecting-yourself-marketing-violations
6. Marketing rules for health plans|Medicare, accessed Jan. 25, 2025, https://www.medicare.gov/health-drug-plans/health-plans/your-coverage-options/plan-marketing-rules
7. Medicare Marketing One-to-One Consent Rules Effective Oct. 1, 2024!—KMT, accessed Jan. 25, 2025, https://kleinmoynihan.com/medicare-marketing-one-to-one-consent-rules-effective-october-1-2024/

We claim:

1. A system comprising:
a lead intake module configured to receive incoming leads;
a lead grading engine configured to evaluate and grade the incoming leads;
a provider/agent database configured to store information about Insurance providers and their agents;
a matching algorithm module configured to match graded leads with appropriate providers and agents;
an appointment scheduling module configured to facilitate appointment setting between matched leads and available agent appointment slots; and
a data analytics and feedback module configured to collect and analyze data from the lead matching, appointment setting, and the engagement/enrollment processes.

2. The system of claim 1, wherein the lead grading engine assigns grades to leads based on factors including demographic information, product interest, engagement level, and predicted likelihood of conversion.

3. The system of claim 1, wherein the matching algorithm module considers lead grades, provider/agent characteristics, plan suitability, agent time-slot availability, and geographical factors in identifying matches.

4. The system of claim 1, wherein the appointment scheduling module interfaces with third-party system (CRM) calendars, manages real-time updates to availability on those agent calendars, and sends notifications and reminders to leads and agents.

5. The system of claim 1, wherein the appointment scheduling module supports ‘real-time’ reading of Agent/Representative personal work calendars, reflected in near real-time within the Applicant system central appointment availability database.

6. The system of claim 1, wherein the data analytics and feedback module captures lead dispositions from the Agent CRM system to generate insights used to refine the matching and grading algorithms and improve system performance.

7. The system of claim 1, further comprising a user interface allowing leads (aka, Shoppers) to review and select from multiple matched appointment slots or other options for connecting with agents.

8. The system of claim 1, wherein the matching algorithm module utilizes machine learning techniques to improve matching accuracy over time.

9. The system of claim 8, wherein the matching algorithm module is configured to collect data on lead dispositioning as feedback to refine the matching algorithm, optimize the lead grading engine, and to improve efficiency of lead distribution.

10. The system of claim 1, wherein the data analytics and feedback module provides performance metrics and insights to lead vendors, product providers/marketers, and their agents.

11. The system of claim 1, further comprising a communication module configured to provide leads with educational materials and meeting preparation or re-scheduling options prior to scheduled appointments.

12. A method for lead matching, appointment setting, lead distribution and supply-chain cost optimization in the lead generation and delivery space, comprising:
receiving an incoming lead through a lead intake module;
evaluating and grading the lead using a lead grading engine;
matching the graded lead with appropriate providers and agents using a matching algorithm module;
presenting provider/agent engagement options to the/Shopper;
based on the option selected by the lead, performing at least one of the following steps:
connecting the lead with a selected agent; or
facilitating appointment scheduling between the lead and selected agent using an appointment scheduling module; and
collecting and analyzing data from the lead matching, appointment setting, and selling/enrollment processes using a data analytics and feedback module.

13. The method of claim 12, wherein evaluating and grading the lead includes considering factors such as demographic information, lead data field validation, engagement level, and likelihood of conversion.

14. The method of claim 12, wherein matching the graded lead includes considering lead grade, provider/agent characteristics, mutual availability, product suitability, and geographical factors.

15. The method of claim 12, wherein facilitating appointment scheduling includes managing availability calendars and automated sending of notifications and reminders.

16. The method of claim 12, further comprising using insights generated by the data analytics and feedback module to refine the matching algorithm.

17. The method of claim 12, wherein presenting provider/agent options to the lead includes displaying agent profiles of potential matches.

18. The method of claim 12, wherein matching the graded lead utilizes machine learning techniques to improve matching accuracy over time.

19. The method of claim 18, wherein the matching algorithm module is configured to collect data on lead dispositioning as feedback to refine the matching algorithm, optimize the lead grading engine, and to improve efficiency of lead distribution.

20. The method of claim 12, further comprising providing lead vendor, marketing channel and agent performance metrics and insights to providers and agents based on data collected and analyzed.

21. The method of claim 12, further comprising automated notifications to facilitate scheduling follow-up actions if the lead is not ready to engage or purchase.

22. The method of claim 12, wherein collecting and analyzing data includes tracking lead interactions by agents throughout the entire process, reading nurturing steps posted by agents (lead dispositioning), timestamping of shopper interactions, and timing of key process events as documented by agents within the system.

23. The method of claim 12, further comprising providing leads with notification of changes, preparatory or educational materials, and timely reminders about their scheduled appointments.
